(19) United States
(12) Patent Application Publication
(10) Pub. No.: US 2003/0175157 A1
(43) Pub. Date: Sep. 18, 2003

(54) Fluid handling methods and systems

(75) Inventors: Kenneth J. Micklash II, San Diego, CA (US); John Isbell, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC

(21) Appl. No.: 10/350,905

(22) Filed: Jan. 24, 2003

Related U.S. Application Data
(60) Provisional application No. 60/351,821, filed on Jan. 25, 2002.

(51) Int. Cl. G01N 1/00

(52) U.S. Cl. 422/70; 422/100

(57) ABSTRACT

The present invention provides fluid handling systems and related methods that include weight scales for detecting weights of fluids disposed in fluid containers. The fluid handling systems, which are typically highly automated, provide for substantially continuous performance of methods that include the use of these fluid handling systems. The invention also provides kits that include various system components.

### CROSS-REFERENCES TO RELATED APPLICATIONS

Pursuant to 35 U.S.C. §119, the present application claims the benefit of and priority to U.S. Application No. 60/351,821, filed on Jan. 25, 2002 by Micklash II et al., the disclosure of which is incorporated by reference in its entirety for all purposes.

### COPYRIGHT NOTIFICATION

Pursuant to 37 C.F.R. §1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### STATEMENT AS TO RIGHTS TO INVENTIONS MADE UNDER FEDERALLY SPONSORED RESEARCH AND DEVELOPMENT

Not Applicable.

### BACKGROUND OF THE INVENTION

Monitoring fluid levels in fluid containers is a significant aspect of many different processes across diverse industries. In certain scientifically-related disciplines, for example, various methods of analysis include introducing source fluids into analytic instrumentation or components to perform the given assay and disposing of waste fluids from such analysis. To further illustrate, liquid chromatographic-based separations typically include flowing solvents from fluid containers to form mobile phases as part of isocratic or gradient elutions. After flowing through a liquid chromatographic column, certain mobile phase components are generally directed to waste containers. During these procedures fluid-levels are typically monitored to ensure that adequate amounts of source solvents are available and that volume capacities of waste containers are not exceeded.

Many pre-existing approaches to fluid-level monitoring and control are sources of limitation to associated processes, such as liquid chromatographic-based separations. For example, many of these approaches lack sufficient automation to permit the associated process to be performed in a continuous or nearly continuous manner. In fact, many fluid-level monitoring techniques are performed manually. Aside from significantly limiting the throughput of the overall process, these approaches also typically involve frequent direct user handling of the fluid reservoirs with the attendant safety risks to the user, as many of these processes include the use of hazardous fluids. Further, even if a particular fluid-level monitoring technique includes some automation, these systems generally lack sufficient scalability to be readily adaptable to varied operating conditions.

From the foregoing, it is apparent that automated fluid handling systems that permit unattended or nearly unattended operation of an associated process are desirable. These and a variety of additional features of the present invention will become evident upon a complete review of the following.

### SUMMARY OF THE INVENTION

The present invention relates generally to fluid handling. More specifically, the invention provides fluid handling systems and related methods that include weight scales that detect weights of fluids disposed in fluid containers. The fluid handling systems of the invention, which are typically highly automated, provide for substantially continuous performance of methods that include the use of these fluid handling systems. In preferred embodiments, for example, fluid handling systems of the invention are included in liquid chromatography systems that are capable of continuously separating assay components from one another, e.g., as part of high throughput screening protocols. The invention also provides kits that include various system components.

In one aspect, the invention relates to a fluid handling system, which in preferred embodiments is automated. The system includes at least one analytic or synthetic component and at least one fluid flow regulator that effects and/or regulates fluid flow through at least one fluid conduit when the fluid conduit is at least in fluid communication with the fluid flow regulator and the analytic or synthetic component. In certain embodiments, the fluid handling system includes one or more analytic components and one or more synthetic components. The fluid flow regulator typically includes at least one pump and optionally, at least one valve. The system also includes at least one weight scale that detects a weight of fluid disposed in at least one fluid container when the fluid container is in sensory communication with the weight scale. In addition, the system includes at least one controller that is operably connected at least to the weight scale and to the fluid flow regulator. The controller is configured to control the fluid flow regulator at least in response to fluid weight data received from the weight scale. In some embodiments, the controller is further configured to send the fluid weight data and/or other information to at least one remote site and/or to receive at least one instruction from the remote site, such as a computer, a cellular telephone, a pager, a personal digital assistant (PDA), or other communication/information appliance. In certain embodiments, the system further includes at least one fluid sensor (e.g., a float, an optical sensor, a pad, or the like) operably connected to the controller and in sensory communication with at least one fluid container and/or at least one fluid conduit, e.g., to detect fluid leakage from those components.

The fluid handling system also generally includes a plurality of fluid containers (e.g., source fluid containers, waste fluid containers, etc.) in which at least one of the fluid containers is in sensory communication with the weight scale, and a plurality of fluid conduits in which one or more of the fluid conduits fluidly communicates with one or more of the fluid containers and at least one of the fluid conduits is operably connected to the fluid flow regulator. In certain embodiments, for example, the system includes at least two weight scales and at least two of the fluid containers are each in sensory communication with a weight scale. Further, in some embodiments, one or more of the fluid containers are disposed in at least one chemical safety cabinet, e.g., for added operator safety. Optionally, at least one fluid container includes a volume capacity that is different from a volume capacity of another member of the plurality of fluid containers. This aspect further illustrates the scalability and adaptability of the systems described herein.

The controller generally includes system software having one or more logic instructions that direct the controller to receive the fluid weight data from the weight scale, and the fluid flow regulator to effect and/or regulate fluid flow to or from selected fluid containers. In some embodiments, for example, the fluid flow regulator directs or stops fluid flow to or from at least one selected fluid container when a weight of fluid in the selected fluid container is above or below a selected amount. In these embodiments, the fluid flow regulator typically further directs the fluid flow to or from at least a second selected fluid container when the weight of fluid in the second selected fluid container is above or below the selected amount.

In another aspect, the invention provides a liquid chromatography system that includes at least one source fluid container, at least one waste fluid container, and at least one weight scale in sensory communication with one or more of the source or waste fluid containers. The system also includes at least one liquid chromatography column, at least one source fluid conduit that fluidly connects the source fluid container to the liquid chromatography column, and at least one waste fluid conduit that fluidly connects the waste fluid container to the liquid chromatography column. Additionally, the system includes at least one fluid flow regulator operably connected to one or more of, e.g., the source fluid container, the waste fluid container, the source fluid conduit, the waste fluid conduit, or the liquid chromatography column, which fluid flow regulator effects and/or regulates fluid flow through the source fluid conduit, the waste fluid conduit, and/or the liquid chromatography column. Further, the system also includes at least one controller that is operably connected at least to the weight scale and to the fluid flow regulator, which controller controls the fluid flow regulator in response to fluid data received from the weight scale.

In preferred embodiments, the liquid chromatography system of the invention is automated. Typically, the system includes a plurality of source and/or waste fluid containers and a plurality of weight scales in which at least one of the source and/or waste fluid containers is in sensory communication with at least one of the weight scales. Optionally, the liquid chromatography system also includes at least one fluid sensor (e.g., a float, an optical sensor, a pad, etc.) operably connected to the controller and in sensory communication with one or more of, e.g., the source fluid container, the waste fluid container, the source fluid conduit, the waste fluid conduit, or the liquid chromatography column.

In still another aspect, the present invention provides a method of handling fluid. The method includes providing a fluid handling system (e.g., an automated system) that includes at least a first weight scale and a plurality of fluid containers in which at least a first fluid container is in sensory communication with the first weight scale. The fluid handling system also includes at least one analytic or synthetic component and at least one fluid conduit that fluidly communicate at least with the first fluid container and with the analytic or synthetic component. In some embodiments, the fluid handling system includes one or more analytic components and one or more synthetic components. In addition, the fluid handling system also includes at least one fluid flow regulator that is operably connected to at least one of the fluid conduits, and at least one controller that is operably connected at least to the first weight scale and to the fluid flow regulator. The fluid flow regulator effects and/or regulates fluid flow through the fluid conduit, while the controller controls the fluid flow regulator in response to fluid weight data received from at least the first weight scale. In some embodiments, one or more of the fluid containers are disposed in at least one chemical safety cabinet, e.g., to provide additional user safety, as mentioned above. The fluid flow regulator typically includes at least one pump and/or another fluid direction component. The method also includes flowing at least one fluid (e.g., at least one hazardous material, etc.) to or from the first fluid container with the fluid flow regulator until a weight of the fluid in the first fluid container detected by the first weight scale is above or below a first selected amount. Optionally, the method further includes sending the fluid weight data and/or other information from the fluid handling system to at least one remote site. As an additional option, the method further includes receiving at least one instruction at the fluid handling system from at least one remote site. The advantages of the method include minimizing user contact with the fluid, which increases user safety relative to fluid handling methods that lack the fluid handling system.

In certain embodiments of the invention, the fluid conduit further fluidly communicates with at least a second fluid container and the method further includes flowing the fluid to or from at least the second fluid container with the fluid flow regulator when the weight of the fluid in the first fluid container detected by the first weight scale is above or below the first selected amount. The fluid flow regulator typically includes at least one valve and the second flowing step optionally includes diverting fluid flow to or from the first fluid container to or from the second fluid container with the valve. In some embodiments, the first and second fluid containers include source fluid containers and the first flowing step includes flowing the fluid from the first fluid container with the fluid flow regulator until the weight of the fluid in the first fluid container detected by the first weight scale is below the first selected amount, and the second flowing step includes stopping fluid flow from the first fluid container when the weight of the fluid in the first fluid container detected by the first weight scale is below the first selected amount and flowing the fluid from the second fluid container with the fluid flow regulator. In other embodiments, the first and second fluid containers include waste fluid containers and the first flowing step includes flowing the fluid to the first fluid container with the fluid flow regulator until the weight of the fluid in the first fluid container detected by the first weight scale is above the first selected amount, and the second flowing step includes stopping fluid flow to the first fluid container when the weight of the fluid in the first fluid container detected by the first weight scale is above the first selected amount and flowing the fluid to the second fluid container with the fluid flow regulator. The fluid handling system optionally includes at least a second weight scale that is operably connected to the controller, which second weight scale is in sensory communication with the second fluid container and the method further includes flowing the fluid to or from the second fluid container with the fluid flow regulator until the weight of the fluid in the second fluid container detected by the second weight scale is above or below a second selected amount. For example, the fluid flow regulator generally stops flowing the fluid through one or more fluid conduits when the weight of the fluid in the second fluid container detected by the second weight scale is above or below the second selected amount.

In some embodiments, the fluid handling system includes a plurality of weight scales that are operably connected to the controller and at least one of the fluid containers is in sensory communication with at least one of the weight scales and the method includes flowing the fluid to or from selected fluid containers with the fluid flow regulator until weights of the fluid in the selected fluid containers detected by selected weight scales that are in sensory communication with the selected fluid containers are above or below selected amounts. The method of handling the fluid according to the present invention is typically continuous.

In certain embodiments, the fluid handling system further includes at least one fluid sensor (e.g., a float, an optical sensor, a pad, etc.) operably connected to the controller and in sensory communication with at least one selected fluid container and/or at least one selected fluid conduit. In these embodiments, the method typically further includes sensing fluids disposed proximal to an external surface of the selected fluid container and/or to an external surface of the selected fluid conduit, if any, with the fluid sensor. For example, the fluid flow regulator generally stops flowing the fluid through at least one of the fluid conduits when the fluid sensor senses the fluids disposed proximal to the external surface of the selected fluid container and/or to the external surface of the selected fluid conduit.

In some preferred embodiments, the fluid handling system further includes one or more analytic components operably connected to at least one selected fluid conduit and the method further includes analyzing at least one fluid component with the analytic components. The analyzing step typically includes separating at least two fluid components from one another, detecting at least one detectable signal produced by the fluid component, and/or detecting at least one chemical or physical property of the fluid component with the analytic components.

In these embodiments, the fluid handling system optionally further includes at least one fluid sensor (e.g., a float, an optical sensor, a pad, or the like) operably connected to the controller and in sensory communication with at least one selected fluid container, at least one selected fluid conduit, and/or the analytic components, and the method further includes sensing fluids disposed proximal to an external surface of the selected fluid container, an external surface of the selected fluid conduit, and/or an external surface of at least one of the analytical components, if any, with the fluid sensor. The fluid flow regulator typically stops flowing the fluid through at least one of the fluid conduits when the fluid sensor senses the fluids disposed proximal to the external surface of the selected fluid container, the external surface of the selected fluid conduit, and/or the external surface of the analytical components. Further, the analytical components generally stop analyzing the fluid component when the fluid sensor senses the fluids disposed proximal to the external surface of the selected fluid container, the external surface of the selected fluid conduit, and/or the external surface of the analytical components.

In certain embodiments, the fluid handling system includes at least a second weight scale that is operably connected to the controller, which second weight scale is in sensory communication with at least a second fluid container and the method further includes flowing the fluid to or from the second fluid container with the fluid flow regulator until the weight of the fluid in the second fluid container detected by the second weight scale is above or below a second selected amount. The fluid flow regulator typically stops flowing the fluid through one or more of the fluid conduits when the weight of the fluid in the second fluid container detected by the second weight scale is above or below the second selected amount. In addition, the analytic components stop analyzing the fluid component when the weight of the fluid in the second fluid container detected by the second weight scale is above or below the second selected amount.

In other preferred embodiments, the fluid handling system includes one or more synthetic components and the method further includes performing one or more synthetic steps with the synthetic components. Exemplary synthetic components include a reaction block, a fluid dispenser, a fluid manifolding device, and the like. The performing step optionally includes, e.g., dispensing one or more fluidic materials and/or washing one or more solid supports.

In these embodiments, the fluid handling system optionally further includes at least one fluid sensor (e.g., a float, an optical sensor, a pad, or the like) operably connected to the controller and in sensory communication with at least one selected fluid container, at least one selected fluid conduit, and/or the synthetic components, and the method further includes sensing fluids disposed proximal to an external surface of the selected fluid container, an external surface of the selected fluid conduit, and/or an external surface of at least one of the synthetic components, if any, with the fluid sensor. The fluid flow regulator typically stops flowing the fluid through at least one of the fluid conduits when the fluid sensor senses the fluids disposed proximal to the external surface of the selected fluid container, the external surface of the selected fluid conduit, and/or the external surface of the synthetic components. Further, the synthetic components generally stop analyzing the fluid component when the fluid sensor senses the fluids disposed proximal to the external surface of the selected fluid container, the external surface of the selected fluid conduit, and/or the external surface of the synthetic components.

In certain embodiments, the fluid handling system includes at least a second weight scale that is operably connected to the controller, which second weight scale is in sensory communication with at least a second fluid container and the method further includes flowing the fluid to or from the second fluid container with the fluid flow regulator until the weight of the fluid in the second fluid container detected by the second weight scale is above or below a second selected amount. The fluid flow regulator typically stops flowing the fluid through one or more fluid conduits when the weight of the fluid in the second fluid container detected by the second weight scale is above or below the second selected amount. In addition, the synthetic components stop analyzing the fluid component when the weight of the fluid in the second fluid container detected by the second weight scale is above or below the second selected amount.

### BRIEF DESCRIPTION OF THE DRAWINGS

FIG. 1 schematically shows certain components of a fluid handling control system according to one embodiment of the invention.

FIG. 2 schematically depicts a fluid handling system according to one embodiment of the invention.

FIG. 3 schematically illustrates a fluid handling system according to one embodiment of the invention.

FIG. 4 schematically shows a representative example liquid chromatography system in which various aspects of the present invention may be embodied.

FIG. 5 is a flowchart showing a method of controlling fluid flow from source fluid containers according to one embodiment of the invention.

FIG. 6 is a flowchart showing a method of controlling fluid flow to waste fluid containers according to one embodiment of the invention.

### DETAILED DISCUSSION OF THE INVENTION

The present invention relates to fluid handling control systems, to fluid handling systems that include these control systems, and to methods of handling fluid that utilize these systems. While this invention is described herein with reference to a few particular embodiments, the description is illustrative of the invention and is not to be construed as limiting the invention, which has utility in a diverse range of disciplines. More specifically, various modifications to the present invention can be made to the preferred embodiments by those skilled in the art without departing from the true scope of the invention as defined by the appended claims. Further, unless defined otherwise, all technical and scientific terms used herein have the same meaning as commonly understood by one of ordinary skill in the art to which the invention pertains. In particular, in describing and claiming the present invention, certain terminology and grammatical variants thereof are used in accordance with the definitions set forth herein.

In overview, the fluid handling systems of the invention include analytic and/or synthetic components and fluid flow regulators that effect and/or regulate fluid flow through fluid conduits that are in fluid communication with the fluid flow regulators and the analytic and/or synthetic components. As used herein, the phrase “analytic component” refers to a device used in performing at least a portion of an analytical process, such as the identification or separation of component parts or constituent elements of a mixture. Analytic components include detectors (e.g., weight scales, fluid sensors, photomultiplier tubes, optical sensors, and the like). In contrast, the phrase “synthetic component,” as used herein, refers to a device used in performing at least a portion of a synthetic process, such as the production of a substance by joining chemical elements, compounds, and/or groups, or by the degradation of a more complex substance. For example, a synthetic process can include a chemical or biochemical synthetic process. Analytic and synthetic components are described further below. The systems of the invention also include weight scales that detect the weights of fluids disposed in fluid containers that are in sensory communication with the weight scales. These systems also include controllers that are operably connected to the weight scales and to the fluid flow regulators. Controllers are configured to control fluid flow regulators in response, e.g., to fluid weight data received from the weight scales and/or to instructions or commands received from other sources, including remote sites.

In preferred embodiments, the fluid handling systems of the invention are automated, which permits fully unattended or nearly unattended fluid handling in a given process. To illustrate, automated fluid flow regulators that are under the control of the controllers of the invention typically continuously direct and/or stop fluid flow to or from selected fluid containers when weights of fluid in those fluid containers are above or below selected or user defined amounts. As used herein, the term “continuous” with respect to a process refers to a process that is marked by uninterrupted extension in sequence for a selected period of time or an indefinite period of time. These aspects of the present invention significantly enhance the throughput of processes that include fluid handling steps relative to those utilizing many of the preexisting fluid handling systems and methods. Unlike the systems of the present invention, many of these pre-existing technologies lack sufficient automation to achieve continuous or uninterrupted process performance. For example, many preexisting systems are halted when a source fluid is depleted or when the capacity of a waste fluid container is reached. This significantly limits the efficiency of processes being performed with these pre-existing systems.

Additional advantages provided by the present invention include improved user safety relative to fluid handling methods that lack the fluid handling systems described herein. For example, the automated fluid handling methods of the invention reduce or minimize human contact with hazardous fluids that may be utilized in a given process, such as various solvents used in high throughput high performance liquid chromatography (HPLC) or the like. The systems and methods of the present invention also provide a high degree of scalability and flexibility. More particularly, they are readily adapted to accommodate the use of assorted fluid container sizes, numbers, and types. Further, these systems and methods are also easily adapted to perform a broad range of processes, including industrial, medical, and scientific processes.

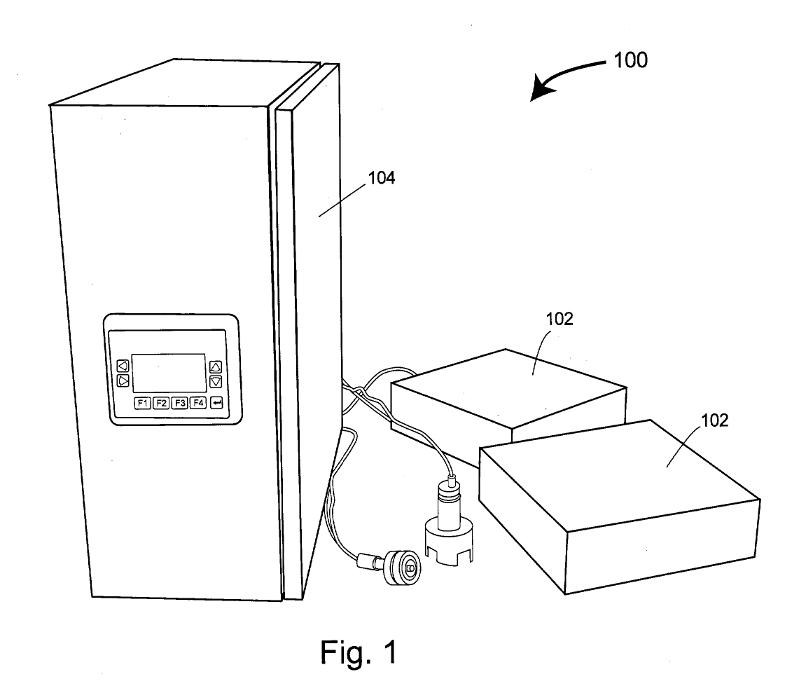

Now referring to FIG. 1, a fluid handling control system of the present invention is schematically illustrated. In the embodiment shown, fluid handling control system 100 includes weight scales 102 and controller 104. Weight scales 102 detect and monitor weights of fluids disposed in fluid containers (not shown) that are in sensory communication with weight scales 102 (e.g., placed on the scales, etc.). Essentially any weight scale can be used or adapted for use in the systems described herein. Suitable weight scales are readily available from various commercial sources. As used herein, the phrase “in sensory communication” with a particular region or component refers to the placement of, e.g., an analytic component in a position such that the analytic component is capable of detecting or analyzing a property of the region or component, a portion of the region or component, or the contents of the region or component or a portion of the region or component, for which the analytic component is intended. Analytic components, such as detectors, typically include or are operably linked to a computer, e.g., which has software for converting analytic component signal information into output or result information (e.g., fluid weight data, etc.), or the like. Controller 104 is configured to control one or more fluid flow regulators, e.g., in response to fluid weight data received from weight scales 102 when controller 104 is further operably connected to the fluid flow regulators. In some embodiments, controller 104 is further configured to send the fluid weight data and/or other information to at least one remote site and/or to receive at least one instruction from the remote site. Controllers and computers are described in greater detail below.

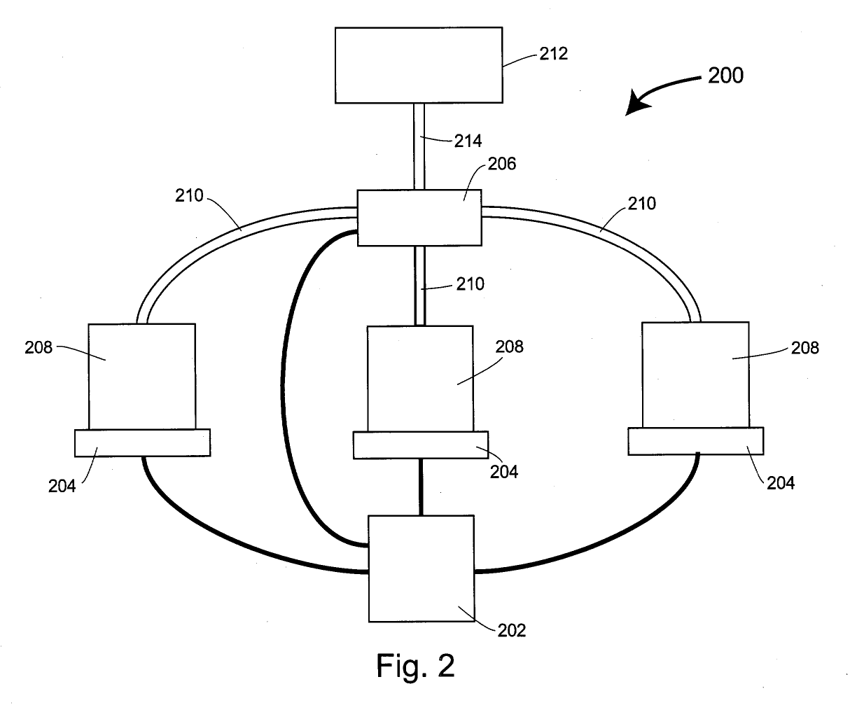

To further illustrate the invention, FIG. 2 schematically depicts one embodiments of a fluid handling system. As shown, fluid handling system 200 includes controller 202 operably connected to weight scales 204 and to fluid flow regulator 206. As described further below, controller 202 typically includes and/or is operably linked to a computer. As also shown, fluid handling system 200 additionally includes fluid containers 208 in sensory communication with weight scales 204 and fluid conduits 210 (e.g., tubes, pipes, channels, cavities, etc.) in fluid communication with fluid containers 208 and with fluid flow regulator 206. Fluid flow regulator 206 also fluidly communicates with analytic (e.g., an HPLC column, etc.) or synthetic (e.g., a fluid manifolding device, etc.) component 212 via fluid conduit 214. Fluid flow regulator 206, which typically includes at least one pump and one or more valves, effects and/or regulates fluid flow through fluid conduits 210 and 214 under the control of controller 202. Suitable fluid flow regulators are generally known in the art and are commercially available.

Fluid handling system 200 is optionally used to handle and monitor source fluids (e.g., solvents used to produce mobile phases in liquid chromatographic-based separations or other analytical processes). During operation, for example, the weight of fluids and their respective fluid containers 208 are typically continuously measured and analyzed by a computer. When the weight of the fluid defined as the default fluid falls below a user defined or selected level (e.g., in one of fluid containers 208), the computer determines whether the weight of fluid in alternate fluid containers 208 is above a user defined level for the particular alternate container. If an alternate fluid container 208 contains more than the user defined level of fluid, then the computer activates a valve of fluid flow regulator 206 such that fluid is flowed from an alternate fluid container 208. If no alternate container is above a user defined level for the particular alternate fluid container 208, then the computer typically signals analytic or synthetic component 212 to shut down. After at least one fluid container 208 is filled above its respective user defined level, the computer typically signals analytic or synthetic component 212 to continue operating. Optionally, a fluid container 208 can be re-filled as soon as its fluid level falls below its respective user defined level, e.g., to achieve continuous operation of analytic or synthetic component 212. In other embodiments, fluid handling system 200 is used to handle and monitor waste fluids (e.g., waste solvents from liquid chromatographic-based separations or other analytical processes). For example, when fluid in a waste container reaches a specified level, the computer signals fluid flow regulator 206 to stop flowing fluids from analytic or synthetic component 212 to that particular waste container. In certain of these embodiments, this signal from the computer is turned off only when the user manually engages a reset button or other form of manual override. Methods of handling source and/or waste fluids from a given analytic or synthetic process using the systems of the invention are described further below.

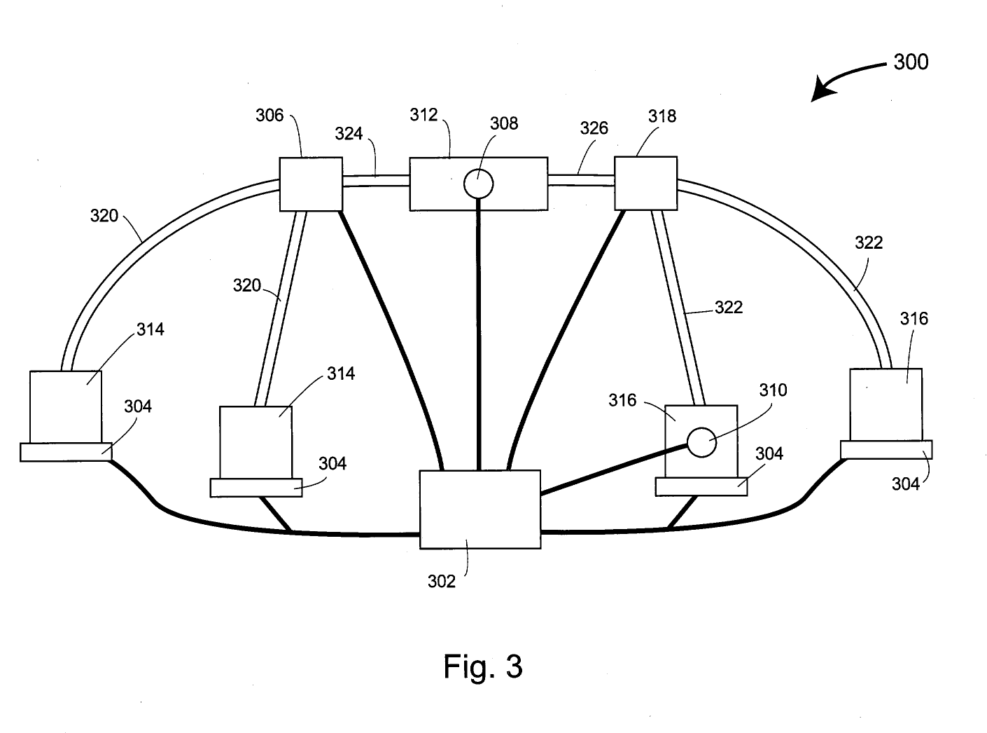

FIG. 3 schematically illustrates another embodiment of a fluid handling system according to the present invention. As shown, fluid handling system 300 includes controller 302 operably connected to weight scales 304, fluid flow regulator 306, and fluid flow regulator 318. Controller 302 is also operably connected to fluid sensors 308 and 310. Fluid sensor 308 is in sensory communication with analytic or synthetic component 312 to sense fluids disposed proximal (e.g., fluid leaks, etc.) to an external surface of analytic or synthetic component 312. In the embodiment shown, fluid sensor 310 is in sensory communication with one waste fluid container 316 to sense fluids disposed proximal (e.g., fluid leaks, etc.) to an external surface of that container. Optionally, fluid sensors are placed in sensory communication with other, or with all, fluid containers of fluid handling system 300. In these embodiments, fluid handling system 300 also checks for or monitors fluid spills or leaks (e.g., for added safety as an emergency backup, e.g., in case of user error, etc.) and typically turns off, e.g., analytic or synthetic component 312, source fluid flow regulator 306, and/or waste fluid flow regulator 318 when such leaks are detected. This monitoring can be performed using essentially any available fluid sensor or fluid level detection device, such as floats, optical sensors, pads, or the like. As an additional option, other non-air sensors are placed in sensory communication with selected system components to sense other materials disposed proximal to external surfaces of those components. Fluid level detection devices and other non-air sensors are generally known in the art to which this invention pertains and are readily available from various commercial sources.

As additionally shown in FIG. 3, source fluid containers 314 and waste fluid containers 316 are in sensory communication with weight scales 304. Source fluid containers 314 fluidly communicate with source fluid flow regulator 306 via source fluid conduits 320, whereas waste fluid containers 316 fluidly communicate with waste fluid flow regulator 318 via waste fluid conduits 322. Source fluid flow regulator 306 is fluidly connected to analytic or synthetic component 312 by fluid conduit 324. Waste fluid flow regulator 318 is fluidly connected to analytic or synthetic component 312 by fluid conduit 326. Fluid handling system 300 is optionally adapted to handle and monitor fluids for various analytic and/or synthetic processes. Exemplary analytic and synthetic components that can be used in these systems are described further below. In preferred embodiments, fluid handling systems of the invention are used in high throughput HPLC systems, e.g., to handle, control, and monitor fluids used in these systems. Another representative example liquid chromatography system is described below.

The analytic and synthetic components of the invention include various embodiments. For example, an analytic component optionally includes at least one detection component that is structured to detect detectable signals produced, e.g., in or proximal to another component of the system. Suitable signal detectors that are optionally utilized in these systems detect, e.g., fluorescence, phosphorescence, radioactivity, mass, concentration, pH, charge, absorbance, refractive index, luminescence, temperature, magnetism, or the like. Detectors optionally monitor one or a plurality of signals from upstream and/or downstream of the performance of, e.g., a given assay step. For example, the detector optionally monitors a plurality of optical signals, which correspond in position to “real time” results. Example detectors or sensors include photomultiplier tubes, CCD arrays, optical sensors, temperature sensors, pressure sensors, pH sensors, conductivity sensors, scanning detectors, or the like. Each of these as well as other types of sensors is optionally readily incorporated into the systems described herein. Optionally, the systems of the present invention include multiple detectors.

Essentially any analytic component can be utilized or adapted for use in the fluid handling systems of the invention. Certain exemplary analytic components that are optionally utilized in these systems include, e.g., a liquid chromatography column, a gel electrophoresis column, a electrochromatography column, a resonance light scattering detector, an emission spectroscope, a fluorescence spectroscope, a phosphorescence spectroscope, a luminescence spectroscope, a spectrophotometer, a photometer, a calorimeter, a mass spectrometer, a nuclear magnetic resonance spectrometer, an electron paramagnetic resonance spectrometer, an electron spin resonance spectroscope, a turbidimeter, a nephelometer, a Raman spectroscope, a refractometer, an interferometer, an x-ray diffraction analyzer, an electron diffraction analyzer, a polarimeter, an optical rotary dispersion analyzer, a circular dichroism spectrometer, a potentiometer, a chronopotentiometer, a coulometer, an amperometer, a conductometer, a gravimeter, a thermal gravimeter, a titrimeter, a differential scanning calorimeter, a radioactive activation analyzer, a radioactive isotopic dilution analyzer, or the like. Analytic components that are optionally included in the systems of the invention are described further in, e.g., Skoog et al., Principles of Instrumental Analysis, 5^{th} Ed., Harcourt Brace College Publishers (1998) and Currell, Analytical Instrumentation: Performance Characteristics and Quality, John Wiley & Sons, Inc. (2000), which are incorporated by reference in their entirety for all purposes.

Various synthetic components are also utilized or adapted for use in the systems of the invention. To illustrate, synthetic components, such as reaction blocks, fluid dispensers, fluid manifolding devices, or the like are optionally used as components of the fluid handling systems described herein. In one embodiment, for example, fluid handling systems are used to monitor fluid levels in source fluid containers from which reagents (e.g., solid support-bound reagents, etc.) are dispensed into reaction block wells using a fluid dispenser, e.g., to perform combinatorial or parallel synthesis reactions in the reaction block. Exemplary reaction blocks that are optionally utilized in the systems of the invention are described further in, e.g., U.S. Ser. No. 09/947,236, entitled “PARALLEL REACTION DEVICES,” filed Sep. 5, 2001 by Micklash II et al., while exemplary fluid dispensing and manifolding devices are described further in, e.g., International Publication No. WO 02/076830, entitled “MASSIVELY PARALLEL FLUID DISPENSING SYSTEMS AND METHODS,” filed Mar. 27, 2002 by Downs et al., U.S. S No. 60/351,821, entitled “DEVICES, SYSTEMS, AND METHODS OF MANIFOLDING MATERIALS,” filed Jan. 25, 2002 by Micklash II et al., Attorney Docket No. 36-000610US, entitled “DEVICES, SYSTEMS, AND METHODS OF MANIFOLDING MATERIALS,” filed Jan. 24, 2003 by Micklash II et al., and Attorney Docket No. 36-000610PC, entitled “DEVICES, SYSTEMS, AND METHODS OF MANIFOLDING MATERIALS,” filed Jan. 24, 2003 by Micklash II et al., the disclosures of which are incorporated by reference in their entirety for all purposes.

The fluid handling systems of the invention also typically include controllers that are operably connected to one or more components (e.g., analytic components, synthetic components, weight scales, fluid flow regulators, etc.) of the system to control operation of the components. More specifically, controllers are generally included either as separate or integral system components that are utilized, e.g., to receive fluid weight data from weight scales, to effect and/or regulate fluid flow to or from selected fluid containers, or the like. Controllers and/or other system components is/are optionally coupled to an appropriately programmed processor, computer, digital device, or other information appliance (e.g., including an analog to digital or digital to analog converter as needed), which functions to instruct the operation of these instruments in accordance with preprogrammed or user input instructions, receive data and information from these instruments, and interpret, manipulate and report this information to the user. In certain embodiments, for example, controllers are configured to send fluid weight data and/or other information to remote sites and/or to receive instructions or commands from remote sites. Methods of sending and/or receiving information to/from remotes sites are generally known in the art. Some of these methods are described further in, e.g., U.S. Pat. No. 6,336,362, entitled “METHOD AND SYSTEM FOR MEASURING AND REMOTELY REPORTING THE LIQUID LEVEL OF TANKS AND THE USAGE THEREOF,” which issued Jan. 8, 2002 to Duenas, the disclosure of which is incorporated by reference in its entirety for all purposes. Suitable controllers are generally known in the art and are available from commercial sources, such as Hardy Instruments (San Diego, Calif.), Kahler Automation Corp. (Fairmont, Minn.), and Rockwell Automation (Milwaukee, Wis.).

Any controller or computer optionally includes a monitor which is often a cathode ray tube (“CRT”) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user. These components are illustrated further below.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation. The computer then receives the data from, e.g., sensors/detectors included within the system, and interprets the data, either provides it in a user understood format, or uses that data to initiate further controller instructions, in accordance with the programming, e.g., such as controlling fluid flow regulators in response to fluid weight data received from weight scales or the like.

The computer can be, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX-based machine, a MACINTOSH™, Power PC, or a UNIX-based (e.g., SUN™ work station) machine) or other common commercially available computer which is known to one of skill. Standard desktop applications such as word processing software (e.g., Microsoft Word™ or Corel WordPerfect™) and database software (e.g., spreadsheet software such as Microsoft Excel™, Corel Quattro PrO™, or database programs such as Microsoft Access™ or Paradox™) can be adapted to the present invention. Software for performing, e.g., controlling fluid flow regulators is optionally constructed by one of skill using a standard programming language such as Visual basic, Fortran, Basic, Java, or the like.

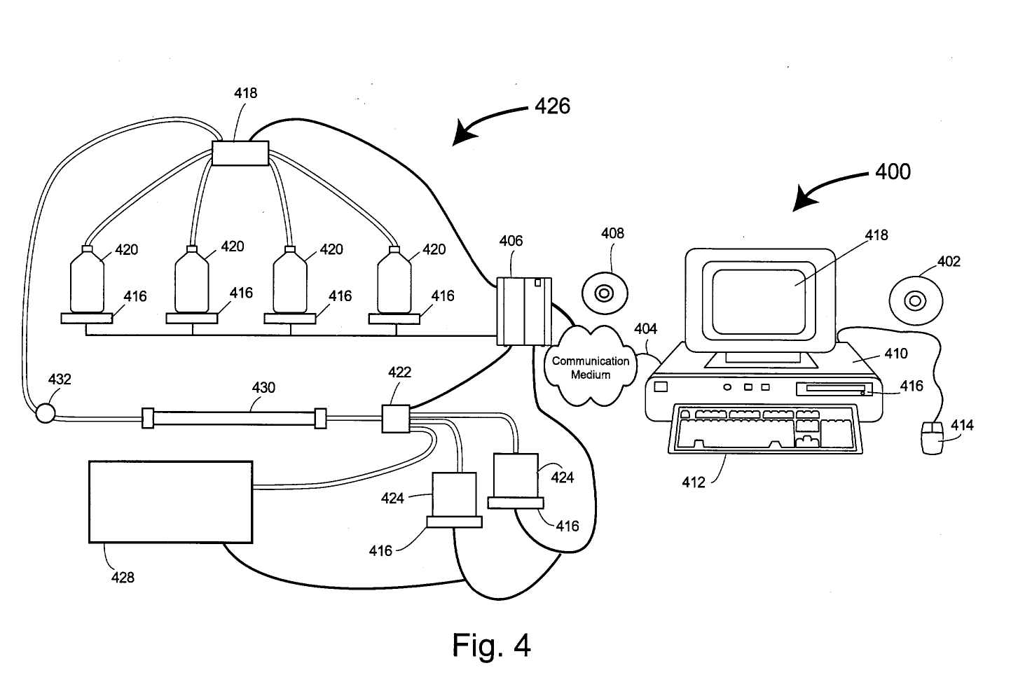

To further illustrate the invention, FIG. 4 provides a schematic showing a representative example high performance liquid chromatography (HPLC) system including a logic device in which various aspects of the present invention may be embodied. As will be understood by practitioners in the art from the teachings provided herein, the invention is optionally implemented in hardware and software. In some embodiments, different aspects of the invention are implemented in either client-side logic or server-side logic. As will also be understood in the art, the invention or components thereof may be embodied in a media program component (e.g., a fixed media component) containing logic instructions and/or data (e.g., fluid weight data, etc.) that, when loaded into an appropriately configured computing device, cause that apparatus or system to perform according to the invention. As will further be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

In particular, FIG. 4 shows information appliance or digital device 400 that may be understood as a logical apparatus (e.g., a computer, etc.) that can read instructions from media 402 and/or network port 404, which can optionally be connected to server/controller 406 having fixed media 408. Digital device 400 can thereafter use those instructions to direct server or client logic, as understood in the art, to embody aspects of the invention. One type of logical apparatus that may embody the invention is a computer system as illustrated in 400, containing CPU 410, optional input devices 412 and 414, disk drives 416 and optional monitor 418. Fixed media 402, or fixed media 408 over port 404, may be used to program such a system and may represent a disk-type optical or magnetic media, magnetic tape, solid state dynamic or static memory, or the like. In specific embodiments, aspects of the invention may be embodied in whole or in part as software recorded on this fixed media. For example, such software may include logic instructions that direct server/controller 406 to receive fluid weight data from weight scales 416, solvent flow regulator 418 to effect and/or regulate solvent flow from solvent containers 420, and waste fluid flow regulator 422 to effect and/or regulate waste fluid flow to waste fluid containers 424. Communication port 404 may also be used to initially receive instructions that are used to program such a system and may represent any type of communication connection. Optionally, aspects of the invention is embodied in whole or in part within the circuitry of an application specific integrated circuit (ACIS) or a programmable logic device (PLD). In such a case, aspects of the invention may be embodied in a computer understandable descriptor language, which may be used to create an ASIC or PLD.

FIG. 4 also includes automated HPLC system 426 that includes a fluid handling system as described herein. As shown, server/controller 406 is further operably connected to flow regulators 418 and 422, weight scales 416, and detection system 428. Optionally, flow regulators 418 and 422, weight scales 416, and/or detection system 428 are directly connected to digital device 400. During operation, solvent flow regulator 418 typically distributes solvents from solvent containers 420 to column 430. Samples to be separated are introduced into the system via sample introduction port 432. Typically, after flowing through column 430, fluids are directed to at least one of waste fluid containers 424 or to detection system 428. Detection system 428 optionally includes a uv spectrometer, a mass spectrometer, or the like to detect separated sample components. Digital device 400 typically digitizes, stores, and manipulates signal information detected by detection system 428 using one or more logic instructions.

Also during operation, server/controller 406 continuously monitors fluid weights in solvent containers 420 and waste fluid containers 424 by receiving fluid weight data from weight scales 416 and controls flow regulators 418 and 422 in response thereto as described herein. For example, if the weight of fluid in one of waste fluid containers 424 reaches a selected amount (e.g., the volume capacity of the particular container), the server/controller 406 causes waste fluid flow regulator 422 to divert fluid flow to the other waste fluid container. In this manner, the waste fluid container having the selected amount can be taken offline to dispose of the waste fluid without halting the entire process.

In some embodiments of the invention, solvent containers 420 and/or waste fluid containers 424 are located in, e.g., standard laboratory flammable material cabinets. In these embodiments, the solvent selection features described herein generally comply with typical safety guidelines relating to, e.g., electrical devices disposed within such flammable material cabinets. In addition, the solvent selection features provided by the present invention increase the solvent capacity accessible to, e.g., HPLC components relative to preexisting devices, while retaining the ability to safely store hazardous materials inside these safety cabinets. Furthermore, the systems of the invention provide improved reliability relative to preexisting systems by, e.g., eliminating sample loss due to the lack of source solvents.

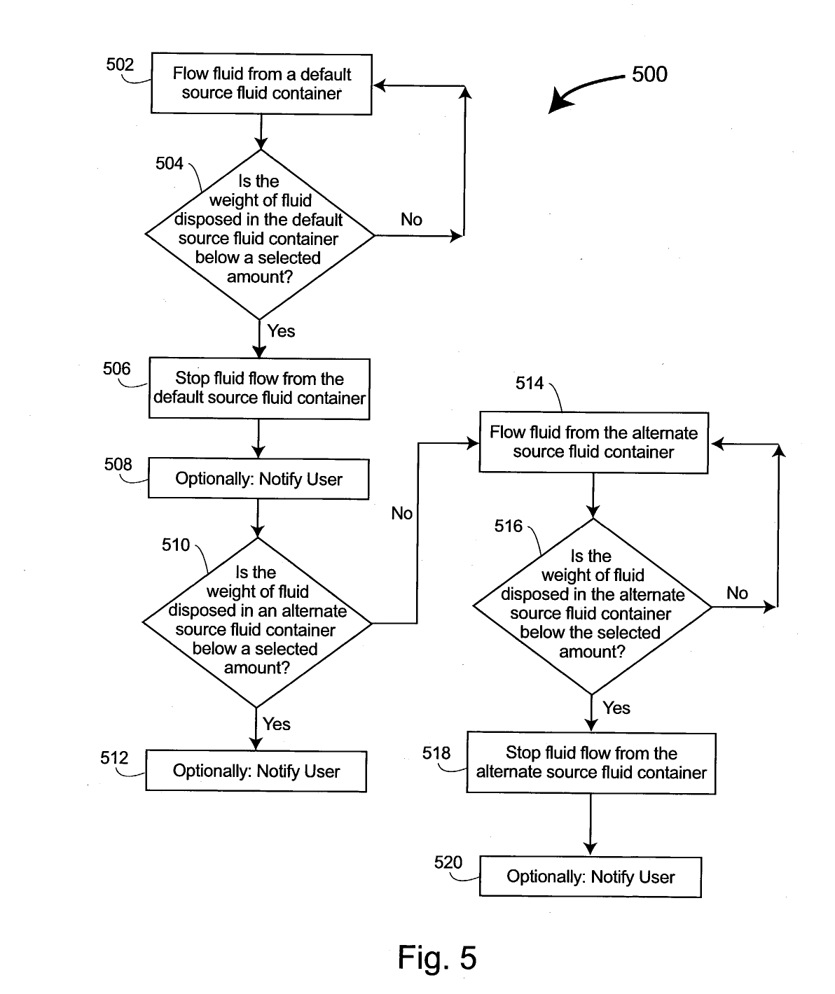

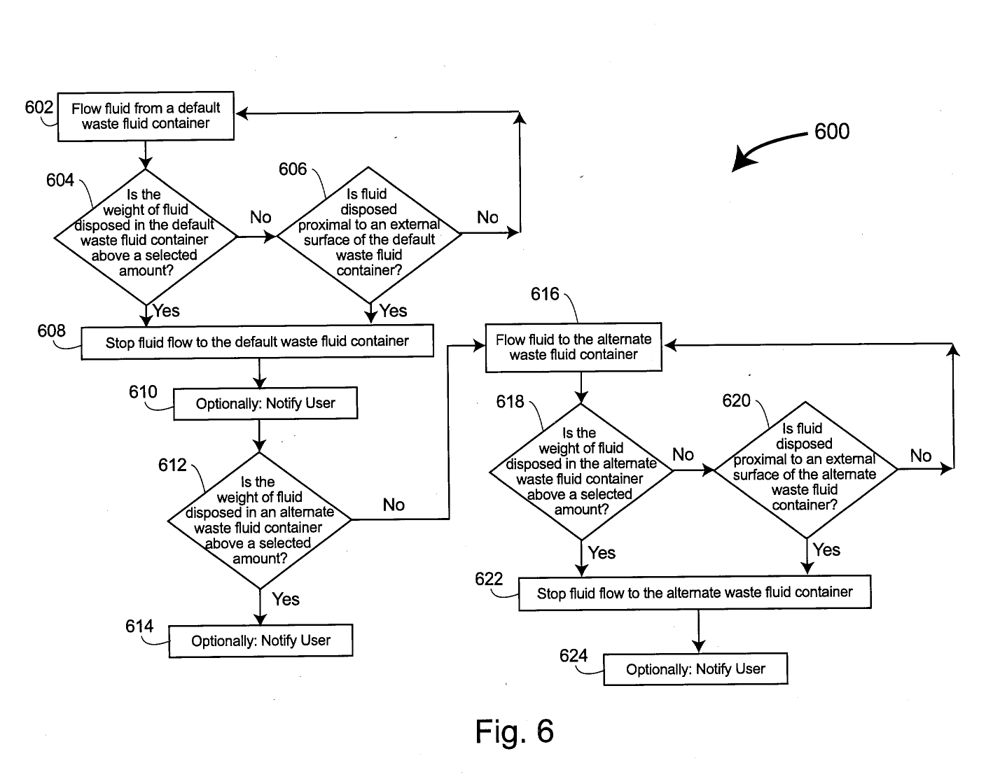

Certain aspects of the methods of handling fluids using the systems described herein are provided in FIGS. 5 and 6. In particular, FIG. 5 is a flowchart showing a method of controlling fluid flow from source fluid containers 500 according to one embodiment of the invention. As shown in block 502, the method includes flowing fluid from a default source fluid container, e.g., to an analytic and/or synthetic component. Block 504 illustrates that the system continually monitors whether the weight of fluid disposed in the default source fluid container is below a selected or user defined amount. If the weight of fluid disposed in the default source fluid container is not below the selected amount, then the system continues to flow fluid from the default source fluid container. If the weight of fluid disposed in the default source fluid container is below the selected amount, then as shown in block 506, the system stops fluid flow from the default source fluid container. As shown in block 508, the system is optionally configured to notify a user (e.g., remotely via an email communication or the like) that the weight of fluid disposed in the default source fluid container is below the selected amount.

Block 510 shows that the system then determines whether the weight of fluid disposed in an alternate source fluid container is below a selected amount. If the weight of fluid disposed in an alternate source fluid container is below a selected amount, then as shown in block 512, the system is optionally configured to notify a user. The system also typically stops the flow of fluid from source fluid containers and the operation of analytic and/or synthetic components that are included in the system. If the weight of fluid disposed in an alternate source fluid container is below a selected amount, then as shown in block 514, the system flows fluid from the alternate source fluid container, e.g., to the analytic and/or synthetic component. As shown in block 516, the system continues to monitor whether the weight of fluid disposed in the alternate source fluid container is below the selected amount. If the weight of fluid disposed in the alternate source fluid container is not below the selected amount, then the system continues to flow fluid from the alternate source fluid container. If the weight of fluid disposed in the alternate source fluid container is below the selected amount, then as shown in block 518, the system stops fluid flow from the alternate source fluid container. The system also generally stops the operation of analytic and/or synthetic components that are included in the system. As shown in block 520, the system is also optionally configured to notify a user that the weight of fluid disposed in the alternate source fluid container is below the selected amount. In certain embodiments, once at least one source fluid container is refilled above its selected amount, the system automatically resumes operation.

FIG. 6 is a flowchart showing a method of controlling fluid flow to waste fluid containers 600 according to one embodiment of the invention. As shown in block 602, the system flows fluid to a default waste fluid container, e.g., from an analytic and/or synthetic component. Block 604 shows that the system continually monitors whether the weight of fluid disposed in the default waste fluid container is above a selected amount. In this embodiment, the system also includes one or more fluid sensors disposed proximal to the default waste fluid container and as shown in block 606 continually monitors whether fluid is disposed proximal to an external surface of the default fluid container. If the weight of fluid disposed in the default waste fluid container is not above a selected amount and/or fluid is not disposed proximal to an external surface of the default fluid container, then the system continues to flow fluid to the default waste container. If the weight of fluid disposed in the default waste fluid container is above a selected amount and/or fluid is disposed proximal to an external surface of the default fluid container, then as shown in block 608, the system stops fluid flow to the default fluid container. The system also typically stops the operation of the analytic and/or synthetic component that is included in the system. As shown in block 610, the system is optionally configured to notify a user that the weight of fluid disposed in the default waste fluid container is above a selected amount and/or fluid is disposed proximal to an external surface of the default fluid container.

Block 612 shows that the system then determines whether the weight of fluid disposed in an alternate waste fluid container is above a selected amount. As shown in block 614, if the weight of fluid disposed in an alternate waste fluid container is above a selected amount, the system is optionally configured to notify a user. Block 616 shows that if the weight of fluid disposed in an alternate waste fluid container is not above a selected amount, the system will flow fluid to the alternate waste fluid container from analytic and/or synthetic components of the system. Block 618 shows that the system continually monitors whether the weight of fluid disposed in the alternate waste fluid container is above a selected amount. In this embodiment, the system also includes one or more fluid sensors disposed proximal to the alternate waste fluid container and, as shown in block 620, continually monitors whether fluid is disposed proximal to an external surface of the alternate fluid container. If the weight of fluid disposed in the alternate waste fluid container is not above a selected amount and/or fluid is not disposed proximal to an external surface of the alternate fluid container, then the system continues to flow fluid to the alternate waste container. If the weight of fluid disposed in the alternate waste fluid container is above a selected amount and/or fluid is disposed proximal to an external surface of the alternate fluid container, then as shown in block 622, the system stops fluid flow to the alternate fluid container. The system also generally stops the operation of the analytic and/or synthetic component that is included in the system. As shown in block 624, the system is optionally configured to notify a user that the weight of fluid disposed in the alternate waste fluid container is above a selected amount and/or fluid is disposed proximal to an external surface of the alternate fluid container. In some embodiments, for example, once waste fluid is disposed of from at least one waste fluid container to bring the fluid level for that container below its selected amount, the system automatically resumes operation.

The present invention also provides kits that include one or more fluid handling systems described herein, or components (e.g., system software, etc.) of such systems. For example, a kit typically includes at least one analytic component (e.g., a liquid chromatography column, etc.) and/or at least one synthetic component (e.g., a fluid manifolding system, etc.), at least one fluid flow regulator, at least one weight scale, and at least one controller as described herein. Kits also generally include fluid conduits (e.g., tubes, etc.) and other components for operably connecting system components together. In certain embodiments, fluid sensors that can be operably connected to, e.g., the controller are also included in the kits of the invention. Kits typically include appropriate instructions for assembling, utilizing, and maintaining the system or components thereof. In addition, the kits of the invention also typically include packaging materials or containers for holding kit components.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

What is claimed is:

1. A fluid handling system, comprising:
at least one analytic or synthetic component;
at least one fluid flow regulator that effects and/or regulates fluid flow through at least one fluid conduit when the fluid conduit is at least in fluid communication with the fluid flow regulator and the analytic or synthetic component;
at least one weight scale that detects a weight of fluid disposed in at least one fluid container when the fluid container is in sensory communication with the weight scale; and,
at least one controller that is operably connected at least to the weight scale and to the fluid flow regulator, which controller is configured to control the fluid flow regulator at least in response to fluid weight data received from the weight scale.

2. The fluid handling system of claim 1, wherein the system is automated.

3. The fluid handling system of claim 1, wherein fluid handling system comprises one or more analytic components and one or more synthetic components.

4. The fluid handling system of claim 1, wherein the analytic component is selected from the group consisting of: a liquid chromatography column, a gel electrophoresis column, a electrochromatography column, a resonance light scattering detector, an emission spectroscope, a fluorescence spectroscope, a phosphorescence spectroscope, a luminescence spectroscope, a spectrophotometer, a photometer, a calorimeter, a mass spectrometer, a nuclear magnetic resonance spectrometer, an electron paramagnetic resonance spectrometer, an electron spin resonance spectroscope, a turbidimeter, a nephelometer, a Raman spectroscope, a refractometer, an interferometer, an x-ray diffraction analyzer, an electron diffraction analyzer, a polarimeter, an optical rotary dispersion analyzer, a circular dichroism spectrometer, a potentiometer, a chronopotentiometer, a coulometer, an amperometer, a conductometer, a gravimeter, a thermal gravimeter, a titrimeter, a differential scanning colorimeter, a radioactive activation analyzer, and a radioactive isotopic dilution analyzer.

5. The fluid handling system of claim 1, wherein the synthetic component is selected from the group consisting of: a reaction block, a fluid dispenser, and a fluid manifolding device.

6. The fluid handling system of claim 1, wherein the controller is further configured to send the fluid weight data and/or other information to at least one remote site and/or to receive at least one instruction from the remote site.

7. The fluid handling system of claim 1, wherein the fluid flow regulator comprises at least one pump.

8. The fluid handling system of claim 7, wherein the fluid flow regulator further comprises at least one valve.

9. The fluid handling system of claim 1, further comprising:
a plurality of fluid containers, wherein at least one of the fluid containers is in sensory communication with the weight scale; and,
a plurality of fluid conduits, wherein one or more of the fluid conduits fluidly communicates with one or more of the fluid containers and at least one of the fluid conduits is operably connected to the fluid flow regulator.

10. The fluid handling system of claim 9, wherein the system comprises at least two weight scales and at least two of the fluid containers are each in sensory communication with a weight scale.

11. The fluid handling system of claim 9, wherein the controller comprises system software having one or more logic instructions that direct:
the controller to receive the fluid weight data from the weight scale; and,
the fluid flow regulator to effect and/or regulate fluid flow to or from selected fluid containers.

12. The fluid handling system of claim 9, wherein one or more of the fluid containers are disposed in at least one chemical safety cabinet.

13. The fluid handling system of claim 9, wherein one or more of the fluid containers are source fluid containers.

14. The fluid handling system of claim 9, wherein one or more of the fluid containers are waste fluid containers.

15. The fluid handling system of claim 9, wherein at least one fluid container comprises a volume capacity that is different from a volume capacity of another member of the plurality of fluid containers.

16. The fluid handling system of claim 9, wherein the fluid flow regulator directs or stops fluid flow to or from at least one selected fluid container when a weight of fluid in the selected fluid container is above or below a selected amount.

17. The fluid handling system of claim 16, wherein the fluid flow regulator further directs the fluid flow to or from at least a second selected fluid container when the weight of fluid in the second selected fluid container is above or below the selected amount.

18. The fluid handling system of claim 9, further comprising:
at least one fluid sensor operably connected to the controller and in sensory communication with at least one fluid container and/or at least one fluid conduit.

19. The fluid handling system of claim 18, wherein the fluid sensor is selected from the group consisting of: a float, an optical sensor, and a pad.

20. A liquid chromatography system, comprising:
at least one source fluid container;
at least one waste fluid container;
at least one weight scale in sensory communication with one or more of the source or waste fluid containers;
at least one liquid chromatography column;
at least one source fluid conduit that fluidly connects the source fluid container to the liquid chromatography column;
at least one waste fluid conduit that fluidly connects the waste fluid container to the liquid chromatography column;
at least one fluid flow regulator operably connected to one or more of: the source fluid container, the waste fluid container, the source fluid conduit, the waste fluid conduit, or the liquid chromatography column, which fluid flow regulator effects and/or regulates fluid flow through the source fluid conduit, the waste fluid conduit, and/or the liquid chromatography column; and,
at least one controller that is operably connected at least to the weight scale and to the fluid flow regulator, which controller controls the fluid flow regulator in response to fluid data received from the weight scale.

21. The liquid chromatography system of claim 20, wherein the system is automated.

22. The liquid chromatography system of claim 20, wherein the system comprises a plurality of source and/or waste fluid containers and a plurality of weight scales, and wherein at least one of the source and/or waste fluid containers is in sensory communication with at least one of the weight scales.

23. The liquid chromatography system of claim 20, further comprising:
at least one fluid sensor operably connected to the controller and in sensory communication with one or more of: the source fluid container, the waste fluid container, the source fluid conduit, the waste fluid conduit, or the liquid chromatography column.

24. The liquid chromatography system of claim 23, wherein the fluid sensor is selected from the group consisting of: a float, an optical sensor, and a pad.

25. A method of handling fluid, the method comprising:
providing a fluid handling system that comprises:
at least a first weight scale;
a plurality of fluid containers, wherein at least a first fluid container is in sensory communication with the first weight scale;
at least one analytic or synthetic component;
at least one fluid conduit that fluidly communicates at least with the first fluid container and with the analytic or synthetic component;
at least one fluid flow regulator that is operably connected to the fluid conduit, which fluid flow regulator effects and/or regulates fluid flow through the fluid conduit; and
at least one controller that is operably connected at least to the first weight scale and to the fluid flow regulator, which controller controls the fluid flow regulator in response to fluid weight data received from at least the first weight scale; and,
flowing at least one fluid to or from the first fluid container with the fluid flow regulator until a weight of the fluid in the first fluid container detected by the first weight scale is above or below a first selected amount, thereby handling the fluid.

26. The method of claim 25, wherein the method minimizes user contact with the fluid, thereby increasing user safety relative to fluid handling methods that lack the fluid handling system.

27. The method of claim 25, wherein the fluid handling system is automated.

28. The method of claim 25, wherein fluid handling system comprises one or more analytic components and one or more synthetic components.

29. The method of claim 25, wherein one or more of the fluid containers are disposed in at least one chemical safety cabinet.

30. The method of claim 25, wherein the fluid flow regulator comprises at least one pump.

31. The method of claim 25, wherein the fluid comprises at least one hazardous material.

32. The method of claim 25, further comprising sending the fluid weight data and/or other information from the fluid handling system to at least one remote site.

33. The method of claim 25, further comprising receiving at least one instruction at the fluid handling system from at least one remote site.

34. The method of claim 25, wherein the fluid conduit further fluidly communicates with at least a second fluid container and the method further comprises:
flowing the fluid to or from at least the second fluid container with the fluid flow regulator when the weight of the fluid in the first fluid container detected by the first weight scale is above or below the first selected amount.

35. The method of claim 34, wherein the fluid flow regulator comprises at least one valve and wherein the second flowing step comprises diverting fluid flow to or from the first fluid container to or from the second fluid container with the valve.

36. The method of claim 34, wherein the first and second fluid containers comprise source fluid containers and the first flowing step comprises flowing the fluid from the first fluid container with the fluid flow regulator until the weight of the fluid in the first fluid container detected by the first weight scale is below the first selected amount, and the second flowing step comprises stopping fluid flow from the first fluid container when the weight of the fluid in the first fluid container detected by the first weight scale is below the first selected amount and flowing the fluid from the second fluid container with the fluid flow regulator.

37. The method of claim 34, wherein the first and second fluid containers comprise waste fluid containers and the first flowing step comprises flowing the fluid to the first fluid container with the fluid flow regulator until the weight of the fluid in the first fluid container detected by the first weight scale is above the first selected amount, and the second flowing step comprises stopping fluid flow to the first fluid container when the weight of the fluid in the first fluid container detected by the first weight scale is above the first selected amount and flowing the fluid to the second fluid container with the fluid flow regulator.

38. The method of claim 34, wherein the fluid handling system comprises at least a second weight scale that is operably connected to the controller, which second weight scale is in sensory communication with the second fluid container and the method further comprises flowing the fluid to or from the second fluid container with the fluid flow regulator until the weight of the fluid in the second fluid container detected by the second weight scale is above or below a second selected amount.

39. The method of claim 38, wherein the fluid flow regulator stops flowing the fluid through one or more fluid conduits when the weight of the fluid in the second fluid container detected by the second weight scale is above or below the second selected amount.

40. The method of claim 25, wherein the fluid handling system comprises a plurality of weight scales that are operably connected to the controller and wherein at least one of the fluid containers is in sensory communication with at least one of the weight scales and the method comprises flowing the fluid to or from selected fluid containers with the fluid flow regulator until weights of the fluid in the selected fluid containers detected by selected weight scales that are in sensory communication with the selected fluid containers are above or below selected amounts.

41. The method of claim 40, wherein the method of handling the fluid is continuous.

42. The method of claim 25, wherein the fluid handling system further comprises at least one fluid sensor operably connected to the controller and in sensory communication with at least one selected fluid container and/or at least one selected fluid conduit, and the method further comprises sensing fluids disposed proximal to an external surface of the selected fluid container and/or to an external surface of the selected fluid conduit, if any, with the fluid sensor.

43. The method of claim 42, wherein the fluid flow regulator stops flowing the fluid through one or more fluid conduits when the fluid sensor senses the fluids disposed proximal to the external surface of the selected fluid container and/or to the external surface of the selected fluid conduit.

44. The method of claim 42, wherein the fluid sensor is selected from the group consisting of: a float, an optical sensor, and a pad.

45. The method of claim 25, wherein the fluid handling system comprises one or more analytic components and the method further comprises analyzing at least one fluid component with the analytic components.

46. The method of claim 45, wherein the analyzing step comprises separating at least two fluid components from one another, detecting at least one detectable signal produced by the fluid component, and/or detecting at least one chemical or physical property of the fluid component with the analytic components.

47. The method of claim 45, wherein the analytic components are selected from the group consisting of: a liquid chromatography column, a gel electrophoresis column, a electrochromatography column, a resonance light scattering detector, an emission spectroscope, a fluorescence spectroscope, a phosphorescence spectroscope, a luminescence spectroscope, a spectrophotometer, a photometer, a calorimeter, a mass spectrometer, a nuclear magnetic resonance spectrometer, an electron paramagnetic resonance spectrometer, an electron spin resonance spectroscope, a turbidimeter, a nephelometer, a Raman spectroscope, a refractometer, an interferometer, an x-ray diffraction analyzer, an electron diffraction analyzer, a polarimeter, an optical rotary dispersion analyzer, a circular dichroism spectrometer, a potentiometer, a chronopotentiometer, a coulometer, an amperometer, a conductometer, a gravimeter, a thermal gravimeter, a titrimeter, a differential scanning calorimeter, a radioactive activation analyzer, and a radioactive isotopic dilution analyzer.

48. The method of claim 45, wherein the fluid handling system further comprises at least one fluid sensor operably connected to the controller and in sensory communication with at least one selected fluid container, at least one selected fluid conduit, and/or the analytic components, and the method further comprises sensing fluids disposed proximal to an external surface of the selected fluid container, an external surface of the selected fluid conduit, and/or an external surface of at least one of the analytic components, if any, with the fluid sensor.

49. The method of claim 48, wherein the fluid flow regulator stops flowing the fluid through at least one of the fluid conduits when the fluid sensor senses the fluids disposed proximal to the external surface of the selected fluid container, the external surface of the selected fluid conduit, and/or the external surface of the analytic components.

50. The method of claim 48, wherein the analytic components stop analyzing the fluid component when the fluid sensor senses the fluids disposed proximal to the external surface of the selected fluid container, the external surface of the selected fluid conduit, and/or the external surface of the analytic components.

51. The method of claim 48, wherein the fluid sensor is selected from the group consisting of: a float, an optical sensor, and a pad.

52. The method of claim 45, wherein the fluid handling system comprises at least a second weight scale that is operably connected to the controller, which second weight scale is in sensory communication with at least a second fluid container and the method further comprises flowing the fluid to or from the second fluid container with the fluid flow regulator until the weight of the fluid in the second fluid container detected by the second weight scale is above or below a second selected amount.

53. The method of claim 52, wherein the fluid flow regulator stops flowing the fluid through one or more fluid conduits when the weight of the fluid in the second fluid container detected by the second weight scale is above or below the second selected amount.

54. The method of claim 52, wherein the analytic components stop analyzing the fluid component when the weight of the fluid in the second fluid container detected by the second weight scale is above or below the second selected amount.

55. The method of claim 25, wherein the fluid handling system comprises one or more synthetic components and the method further comprises performing one or more synthetic steps with the synthetic components.

56. The method of claim 55, wherein the performing step comprises dispensing one or more fluidic materials and/or washing one or more solid supports.

57. The method of claim 55, wherein the synthetic components are selected from the group consisting of: a reaction block, a fluid dispenser, and a fluid manifolding device.

58. The method of claim 55, wherein the fluid handling system further comprises at least one fluid sensor operably connected to the controller and in sensory communication with at least one selected fluid container, at least one selected fluid conduit, and/or the synthetic components, and the method further comprises sensing fluids disposed proximal to an external surface of the selected fluid container, an external surface of the selected fluid conduit, and/or an external surface of at least one of the synthetic components, if any, with the fluid sensor.

59. The method of claim 58, wherein the fluid flow regulator stops flowing the fluid through at least one of the fluid conduits when the fluid sensor senses the fluids disposed proximal to the external surface of the selected fluid container, the external surface of the selected fluid conduit, and/or the external surface of the synthetic components.

60. The method of claim 58, wherein the synthetic components stop performing the synthetic steps when the fluid sensor senses the fluids disposed proximal to the external surface of the selected fluid container, the external surface of the selected fluid conduit, and/or the external surface of the synthetic components.

61. The method of claim 58, wherein the fluid sensor is selected from the group consisting of: a float, an optical sensor, and a pad.

62. The method of claim 55, wherein the fluid handling system comprises at least a second weight scale that is operably connected to the controller, which second weight scale is in sensory communication with at least a second fluid container and the method further comprises flowing the fluid to or from the second fluid container with the fluid flow regulator until the weight of the fluid in the second fluid container detected by the second weight scale is above or below a second selected amount.

63. The method of claim 62, wherein the fluid flow regulator stops flowing the fluid through one or more fluid conduits when the weight of the fluid in the second fluid container detected by the second weight scale is above or below the second selected amount.

64. The method of claim 62, wherein the synthetic components stop performing the synthetic steps when the weight of the fluid in the second fluid container detected by the second weight scale is above or below the second selected amount.

65. A kit, comprising:
at least one fluid handling system that comprises:
at least one analytic or synthetic component;
at least one fluid flow regulator that effects and/or regulates fluid flow through at least one fluid conduit when the fluid conduit is in fluid communication with the fluid flow regulator and the analytic or synthetic component;
at least one weight scale that detects a weight of fluid disposed in at least one fluid container when the fluid container is in sensory communication with the weight scale; and
at least one controller that is operably connected at least to the weight scale and to the fluid flow regulator, which controller is configured to control the fluid flow regulator at least in response to fluid weight data received from the weight scale; and,
at least one set of instructions that directs use of the fluid handling system.
